(19) United States
(12) Patent Application Publication
(10) Pub. No.: US 2005/0129993 A1
(43) Pub. Date: Jun. 16, 2005

(54) Purging anode channels of a fuel cell stack

(76) Inventors: Elwood A. Eisler, Albany, NY (US); Steven J. Shufon, Troy, NY (US); David A. Marshall, Valley Falls, NY (US)

Correspondence Address: Fred G. Pruner, Jr.;TROP, PRUNER & HU, P.C., Suite 100, 8554 Katy Freeway, Houston, TX, 77024-1841, US

(21) Appl. No.: 10/737,621

(22) Filed: Dec. 16, 2003

(51) Int. Cl. H01M 8/04; H01M 8/10; H01M 8/12; H01M 2/14; H01M 8/18; H01M 8/00

(52) U.S. Cl. 429/17; 429/13; 429/19; 429/22; 429/23; 429/32; 429/25; 429/38; 429/39

(57) ABSTRACT

A technique that is usable with a fuel cell system includes establishing a path to route an anode exhaust from the fuel cell system back to an anode inlet port of the stack. The technique includes diverting part of a first flow otherwise flowing through the path to produce a diverted flow and combining the diverted flow with a flow that is associated with a cathode of the stack.

### BACKGROUND

The invention generally relates to purging anode channels of a fuel cell stack.

A fuel cell is an electrochemical device that converts chemical energy that is produced by a reaction directly into electrical energy. For example, one type of fuel cell includes a polymer electrolyte membrane (PEM), often called a proton exchange membrane, that permits only protons to pass between an anode and a cathode of the fuel cell. At the anode, diatomic hydrogen (a fuel) is reacted to produce hydrogen protons that pass through the PEM. The electrons produced by this reaction travel through circuitry that is external to the fuel cell to form an electrical current. At the cathode, oxygen is reduced and reacts with the hydrogen protons to form water. The anodic and cathodic reactions are described by the following relationships:
H₂→2H⁺+2e⁻ Eq. 1
at the anode of the cell, and
O₂+4H⁺+4e⁻→2H₂O Eq.2
at the cathode of the cell.

A typical fuel cell has a terminal voltage near one volt DC. For purposes of producing much larger voltages, several fuel cells may be assembled together to form a fuel cell stack, an arrangement in which the fuel cells are electrically coupled together in series to form a larger DC voltage (a voltage near 100 volts DC, for example) and to provide more power.

The fuel cell stack may include flow plates (graphite composite or metal plates, as examples) that are stacked one on top of the other, and each plate may be associated with more than one fuel cell of the stack. The plates may include various surface flow channels and orifices to, as examples, route the reactants and products through the fuel cell stack. Several PEMs (each one being associated with a particular fuel cell) may be dispersed throughout the stack between the anodes and cathodes of the different fuel cells. Electrically conductive gas diffusion layers (GDLs) may be located on each side of each PEM to form the anode and cathodes of each fuel cell. In this manner, reactant gases from each side of the PEM may leave the flow channels and diffuse through the GDLs to reach the PEM.

The fuel cell stack may be used in a fuel cell system that routes the anode exhaust from the stack back into the anode input channels of the stack. This type of arrangement is called a “dead-ended” configuration. A potential problem with this arrangement is that inert gases, such as nitrogen, may accumulate in the fuel cell stack, as no exit path from the stack exists for these gases. Therefore, an inert gas, such as nitrogen, may accumulate to a concentration that degrades the performance of the fuel cell stack.

Thus, there is a continuing need for an arrangement and/or technique to address one or more of the problems that are set forth above as well as possibly address one or more problems that are not set forth above.

### SUMMARY

In an embodiment of the invention, a technique that is usable with a fuel cell system includes establishing a path to route an anode exhaust from the fuel cell system back to an anode inlet port of the stack. The technique includes diverting part of a first flow otherwise flowing through the path to produce a diverted flow; and the method includes combining the diverted flow with a flow that is associated with a cathode of the stack.

Advantages and other features of the invention will become apparent from the following description, drawing and claims.

### BRIEF DESCRIPTION OF THE DRAWING

FIGS. 1, 2, 4, 6 and 7 are schematic diagrams of fuel cell systems according to different embodiments of the invention.

FIGS. 3 and 5 are flow charts depicting techniques to control a fuel cell system according to different embodiments of the invention.

### DETAILED DESCRIPTION

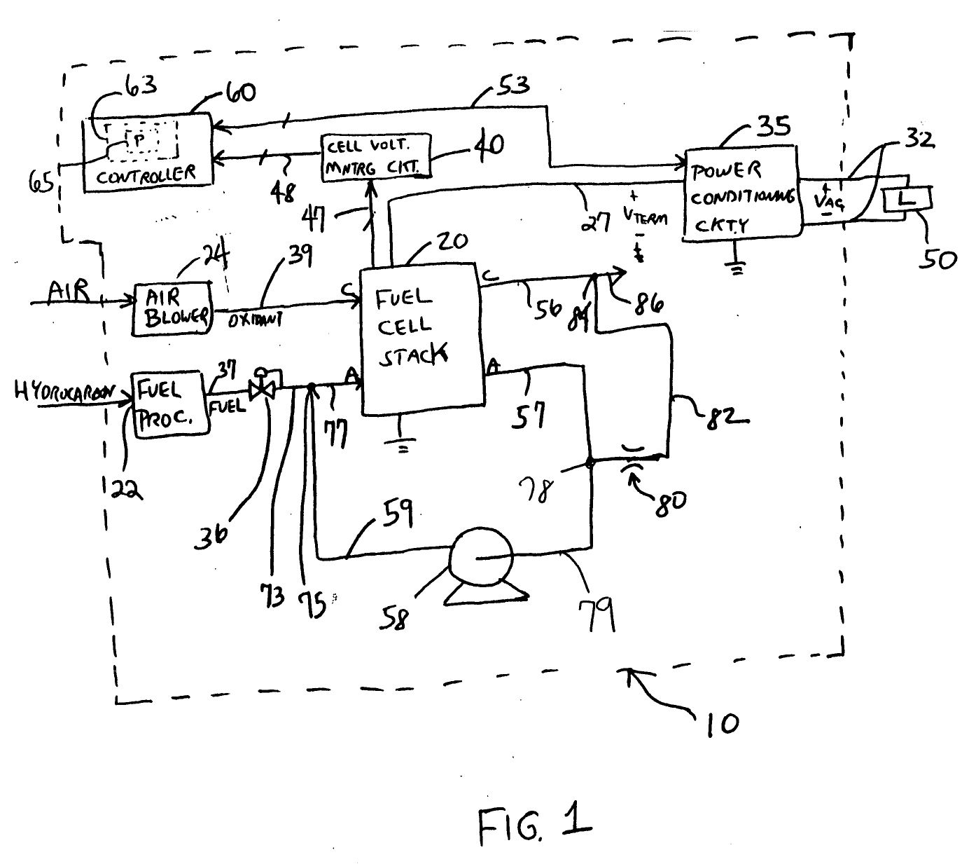

Referring to FIG. 1, an embodiment of a fuel cell system 10 in accordance with the invention includes, among other components, a fuel cell stack 20, a fuel processor 22 (a reformer, for example) and an air blower 24. The fuel cell stack 20 produces power for a load 50 in response to fuel and oxidant (i.e., reactant) flows that are provided by the fuel processor 22 and the air blower 24, respectively. More specifically, the fuel cell system 10 includes a controller to, among its other functions (described herein) controls the power that is produced by the fuel cell stack 20 by controlling the fuel processor 22 to regulate the fuel flow that the processor 22 provides to the stack 20. The fuel flow exits an outlet port 37 of the fuel processor 22 and is pressure-regulated by a pressure regulator 36 before entering the fuel cell stack 20 through an anode inlet port 77. The oxidant flow leaves the air blower 24 and enters a cathode inlet port 39 of the fuel cell stack 20.

In some embodiments of the invention, the fuel cell system 10 establishes an anode circulation path between the anode exhaust 57 and anode inlet 77 ports of the fuel cell stack 20. More particularly, to create this path, the fuel cell system 10 includes an exhaust gas re-circulation (EGR) blower 58 to pressurize the anode exhaust flow exiting the fuel cell stack 20 (having a pressure of about zero pounds per square inch, gauge (psig), in some embodiments of the invention) to convert this exhaust flow into an anode inlet flow (having a pressure of about one psig, in some embodiments of the invention). As described below, the flow from the outlet port of the EGR blower 58 is routed back into the anode inlet port of the fuel cell stack 20. Thus, an anode circulation path is formed from the following components: the anode inlet port 77, anode channels of the fuel cell stack 20, the anode exhaust port 57, an inlet port 79 to the EGR blower 58, the flow path through the blower 58 and the blower's outlet port 59 that is connected (via a T coupler 75) back to the anode inlet port 77. The T coupler 75 joins an outlet port 73 of the pressure regulator 36, the outlet port 59, and the anode inlet port 77 together so that the anode inlet port 77 receives the anode exhaust from the fuel cell stack 20 and fuel from the fuel processor 22.

A potential problem with the above-described circulation path is that concentrations of contaminants (inert gases, such as nitrogen) may reach levels that may degrade performance of the system. However, to maintain the concentrations of contaminants at acceptable levels, the fuel cell system 10 includes a valve 80 to establish a small bleed flow from the path that exists between the anode exhaust port 57 and anode inlet port 77. This bleed flow, in turn, purges contaminants from the anode channels of the fuel cell stack 20. Because the bleed flow is significantly smaller than the flow exiting the anode exhaust port 57, only a small amount of fuel (hydrogen) exits through the bleed flow path. As an example, in some embodiments of the invention, the rate of the bleed flow may be about 1/400th that of the rate of the flow exiting the anode exhaust port 57. Other relative flow rates are possible in other embodiments of the invention. Even though the bleed flow is relatively small, the bleed flow is sufficient to maintain the concentrations of contaminants in the anode circulation path at acceptable levels.

In some embodiments of the invention, the valve 80 may be a valve that has a fixed cross-sectional flow path. In other words, the cross-sectional flow path of the valve is permanent and therefore, does not vary over time. More specifically, in some embodiments of the invention, the input port to the valve 80 is connected to a T coupler 78 that, in turn, couples the input port of the valve 80, the anode exhaust port 57 of the fuel cell stack 20 and the inlet port 79 of the EGR blower 58 together. The flow path through the valve 80 provides a bleed flow path for nitrogen gas to escape the anode circulation path between the anode outlet port 57 and the anode inlet port 77 of the fuel stack 20. Some hydrogen gas may also pass through the bleed flow path. However, the bleed flow is sufficiently very small to release a safe concentration of hydrogen, as shown by way of specific example above. Furthermore, in some embodiments of the invention, the bleed flow is routed to the cathode exhaust plenum to dilute the overall system emissions below hydrogen concentrations that would require special safety or siting considerations.

More specifically, in some embodiments of the invention, the outlet port of the valve 80 is connected by a conduit 82 and a T coupler 84 to the cathode exhaust flow path. In this manner, the T coupler 84 couples the conduit 82, the cathode outlet port 56 and a cathode exhaust path 86 (i.e., the path containing the exhaust from the cathode channels of the fuel cell stack 20) together, as depicted in FIG. 1. Thus, in some embodiments of the invention, the bleed flow path is combined with the cathode exhaust to dilute the concentrations of gases in the bleed flow.

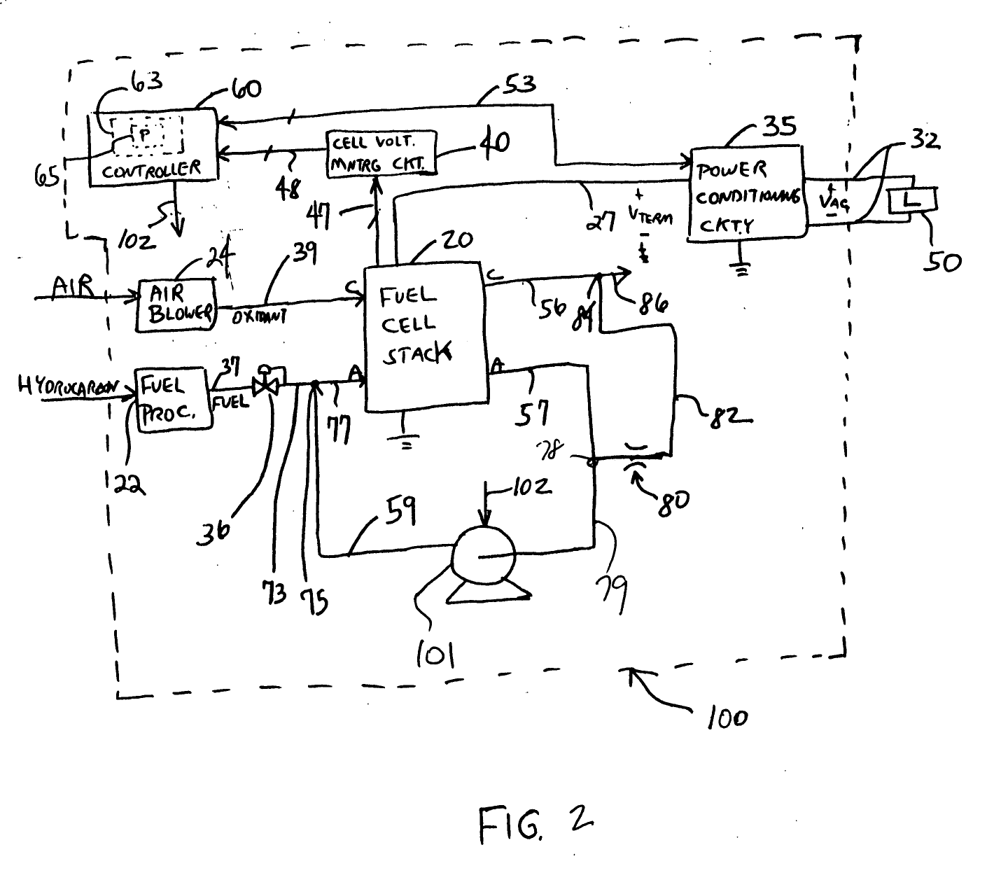

Many other variations are possible from the arrangement that is depicted in FIG. 1. For example, in some embodiments of the invention, the fuel cell system 10 may be replaced by a fuel cell system 100 that is depicted in FIG. 2. Referring to FIG. 2, the fuel cell system 100 has a design that is similar to the fuel cell system 10, except that in the fuel cell system 100, the EGR blower 58 of the fuel cell system 10 is replaced by a variable speed EGR blower 101. The variable speed EGR blower 101, in turn, in some embodiments of the invention, is coupled to communication lines 102 that extend to the controller 60. These communication lines 102, in turn, permit the controller 60 to regulate the flow rate through the anode circulation path based on one or more system parameters.

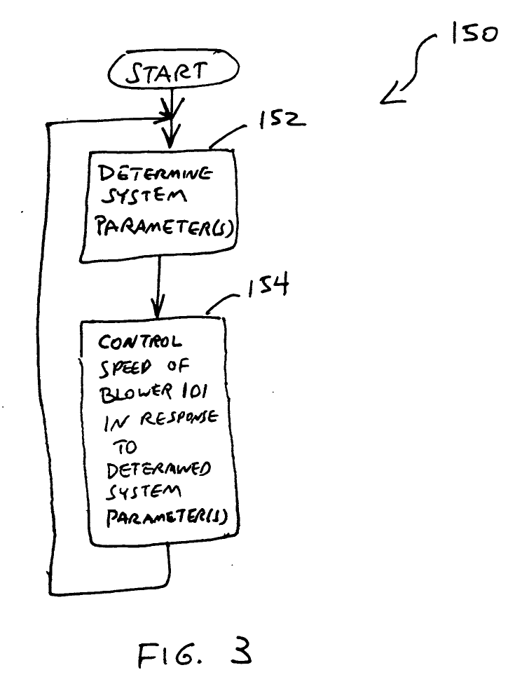

More specifically, in some embodiments of the invention, the controller 60 may control the speed of the EGR blower 101 (and thus, control the flow through the anode re-circulation path) in accordance with a technique 150 that is depicted in FIG. 3. Referring to both FIGS. 2 and 3, pursuant to the technique 150, the controller 60 may determine (block 152) one or more system parameters for purposes of controlling the speed of the blower 101. As examples, these system parameters may include a power output of the system 100 (i.e., the power furnished to the load 50), an output current of the fuel cell system 100 (i.e., the current provided to the load 50), a system voltage (a stack voltage, an output voltage at the load 50, or some voltage in between the load 50 and the stack 20, as just a few examples) or a rate of the cathode flow (input or output flow). Depending on the particular embodiment of the invention, the controller 60 may (through the use of various system sensors, for example) determine other and/or different system parameters.

However, regardless of the system parameters that are determined by the controller 60, pursuant to the technique 150, the controller controls (block 154) the speed of the blower 101 in response to the determined system parameter(s). For example, in some embodiments of the invention, the controller 60 may increase the speed of the blower 101 to increase the flow through the anode re-circulation path to accommodate an increased output power, current or voltage from the fuel cell system 101. In response to a decreased output power, current or voltage, in some embodiments of the invention, the controller 60 may decrease the speed of the blower 101 to decrease the flow through the anode re-circulation path. Depending on the particular embodiment of the invention, when determining the appropriate speed of the blower 101, the controller 60 may assign different weights to different system parameters, i.e., some system parameters may have a greater weight on the speed of the blower 101 than others. Thus, unlike the fuel cell system 10, the fuel cell system 100 varies the speed of the blower 101 (i.e., controls the flow rate through the anode circulation path) in response to one or more determined system parameters.

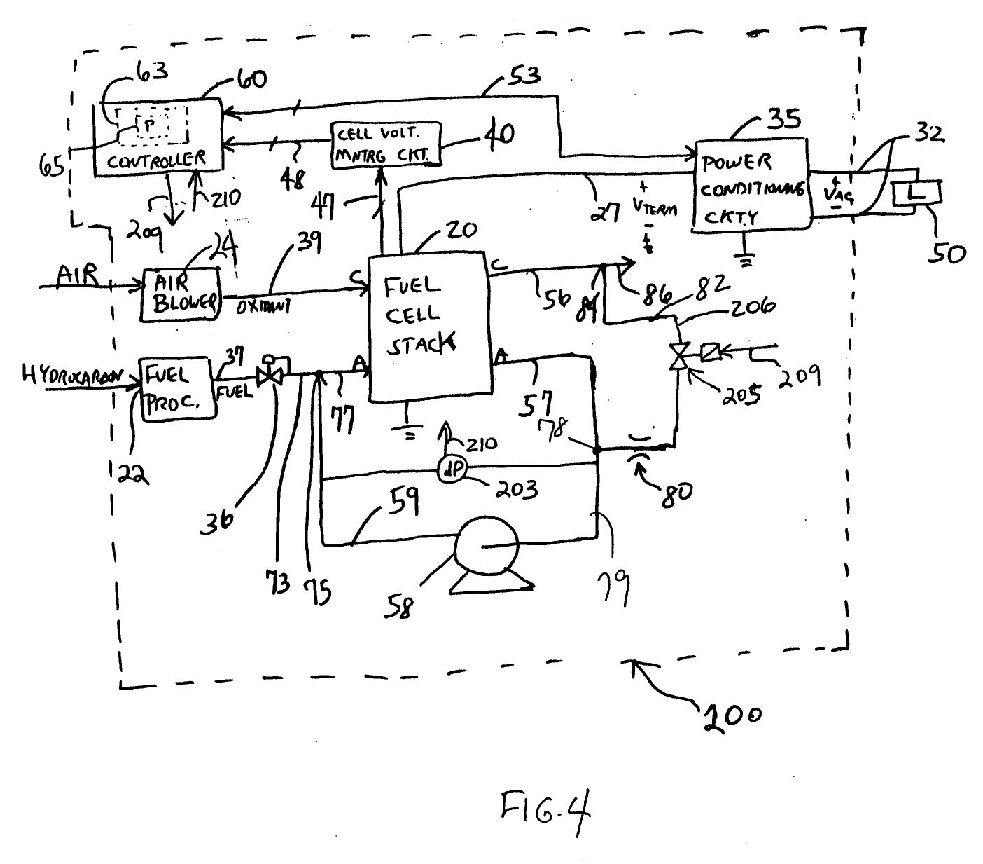

Referring to FIG. 4 as another example of additional embodiment of the invention, the fuel cell system 10 or 100 may be replaced by a fuel cell system 200. The fuel cell system 200 has a similar design to the fuel cell system 10, with the following exceptions. In particular, unlike the fuel cell system 10, the fuel cell system 200 varies the rate of the bleed flow in response to one or more system parameters.

To accomplish this, the fuel cell system 200, in some embodiments of the invention, includes an additional valve 205 in the bleed flow path. Unlike the valve 80, the cross-sectional area of the valve 205 is not permanently fixed, but rather, the cross-sectional area is controlled by the controller 60 for purposes of regulating the flow rate through the bleed flow path. Thus, in some embodiments of the invention, the controller 60 communicates with the valve 205 via one or more communication lines 209 for purposes of regulating the flow rate through the valve 205. In some embodiments of the invention, the inlet port to the valve 205 is connected to the outlet port of the valve 80, and the conduit 82 connects the outlet port of the valve 205 to the T coupler 84.

As also depicted in FIG. 4, in some embodiments of the invention, the fuel cell system 200 includes a differential pressure sensor 203 that is connected to sense the difference between the pressure appearing at the anode inlet port 77 and the pressure appearing at the anode exhaust port 57. The differential pressure sensor 203 is coupled to communication lines 210 that extend to the controller 60. Due to this arrangement, the controller 60 may monitor the differential pressure between the anode inlet and outlet ports of the fuel cell stack 20 and control the bleed flow path accordingly. For example, in some embodiments of the invention, the controller 60 may increase the bleed flow path in response to an increased differential pressure and decrease the bleed flow in response to a decreased differential pressure.

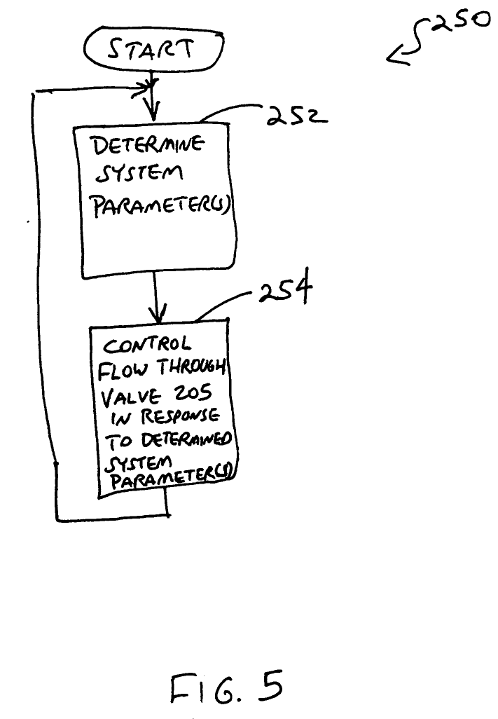

The differential pressure, however, is one out of many possible system parameters that the controller 60 may evaluate for purposes of regulating the rate of the bleed flow. More specifically, in some embodiments of the invention, the controller 60 may perform a technique 250 that is depicted in FIG. 5. Referring to both FIGS. 4 and 5, pursuant to the technique 250, the controller 60 may determine (block 255) one or more system parameters. The system parameters may include an output current, an output power, a system voltage, a differential pressure between the anode inlet and outlet ports, etc. In response to the determined system parameter(s), the controller 60 communicates (via the communication lines 209) with the valve 205 to control the flow through the flow rate through valve 205 (and thus, control the bleed flow rate), as depicted in block 254. For example, the case of the controller 60 controlling the valve 205 in response to the differential pressure between the anode inlet and outlet ports is discussed above. As another example, in some embodiments of the invention, the controller 60 may increase the rate of flow through the bleed flow path in response to an increased system output power, current or voltage. The controller 60 may decrease rate of flow through the bleed flow path in response to a decreased output system current, power or voltage, in some embodiments of the invention. Other variations are possible.

FIG. 4 depicts the valves 80 and 205 as being serially connected, i.e., the fixed flow path of a valve 80 is connected to the variable-sized flow path of the valve 205. Thus, as depicted in FIG. 4, in some embodiments of the invention, the bleed flow path may always provide some level of bleed flow from the anode circulation path. In some embodiments of the invention, however, the fuel cell system may not include the valve 80. Instead, in these embodiments of the invention, the fuel cell system may include only the valve 205. Other variations are possible.

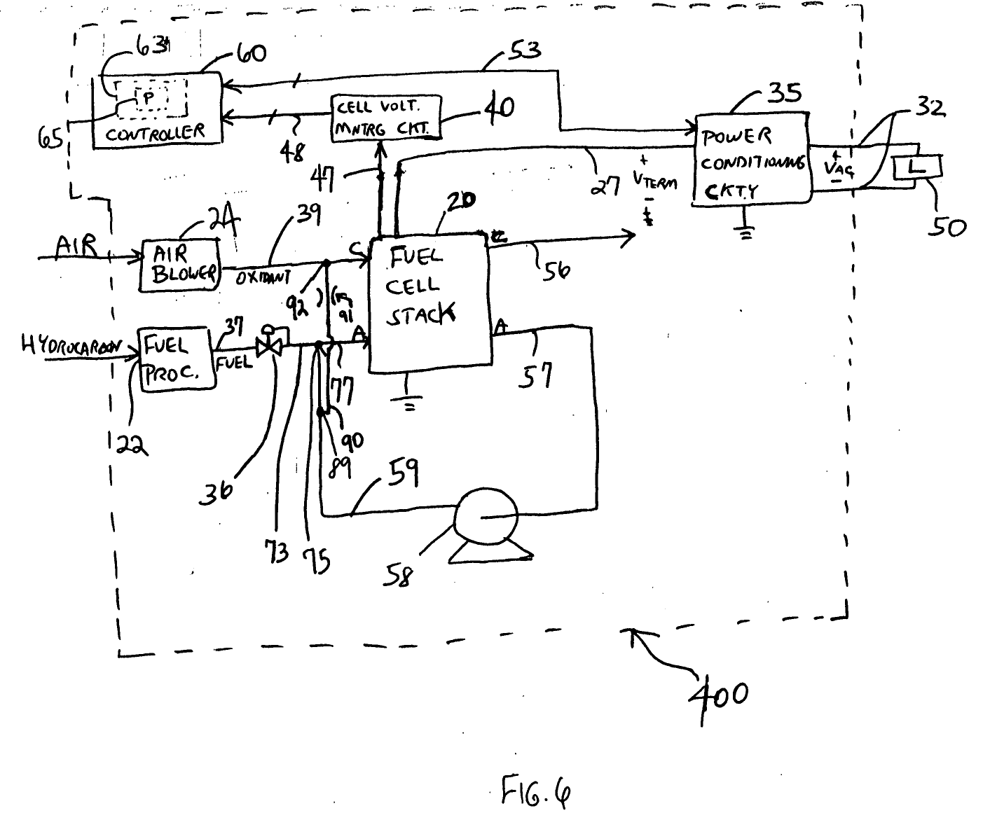

As yet another example of a possible embodiment of the invention, FIG. 6 depicts a fuel cell system 400 that has similar features to the fuel cell system 10, except that a bleed flow path is communicated to an inlet of the cathode flow through the fuel cell stack 20 instead of being communicated to the cathode exhaust flow. More specifically, in some embodiments of the invention, the anode outlet port 57 of the fuel cell stack 20 is connected directly to the inlet port of the blower 50. The bleed flow path, in turn, is connected to the outlet port 59 of the blower 58. More specifically, a T coupler 89 connects the outlet port 59, a conduit 90, and the T coupler 75 together. The conduit 90, in turn, is coupled in line with a flow restriction valve 91 (replacing the valve 80 of the system 10), and the outlet port of the valve 91 is coupled to a T coupler 92. The T coupler 92, in turn, couples the cathode inlet port of the fuel cell stack 20, the conduit 39 and the outlet port of the valve 91 together. Thus, the fuel cell system 400 has a similar design to the fuel cell system 10, except that the bleed flow path is routed to the cathode inlet flow to the stack 20, instead of to the cathode outlet flow from the stack 20.

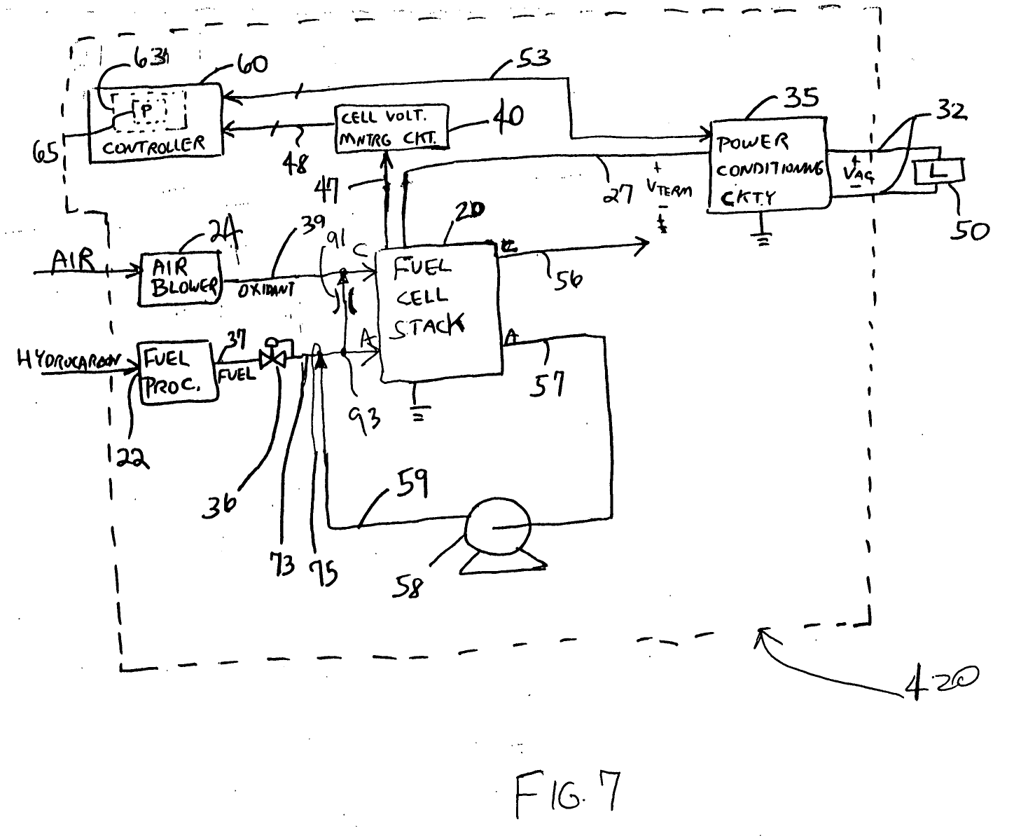

FIG. 7 depicts a fuel cell system 420 in accordance with another embodiment of the invention. The fuel cell system 420 has a similar design to the fuel cell system 400 except that the fuel cell system 420 does not include a connection (such as the conduit 90 in the fuel cell system 400) from the anode circulation path to the cathode inlet stream. Instead, in the fuel cell system 420, the inlet of the flow restriction valve 91 is connected to the anode inlet stream. More specifically, in the fuel cell system 420, the inlet of the valve 91 is connected to an inlet of a T coupler 75. Another inlet of the coupler 75 is connected to the outlet port 73 of the pressure regulator 36; and the outlet of the coupler 75 is connected to the anode inlet port 77. Thus, to summarize, in the fuel cell system 400 (FIG. 6), the bleed flow path to the cathode inlet port taps into the anode circulation path; and in the fuel cell system 420 (FIG. 7), the bleed flow path originates closer to the anode inlet port.

Many other variations are possible from the arrangements described above. In this manner, elements from the various fuel cell systems 10, 100, 200, 400 and 420 may be combined in other embodiments of the invention. For example, in some embodiments of the invention, the fixed speed EGR blower 58 of the fuel cell system 200 (FIG. 4) may be replaced by a variable speed blower that the controller 60 controls in accordance with one or more system parameters. Many other variations are possible and are within the scope of the appended claims.

Referring back to FIG. 1, the fuel cell system 10 contains additional features (also contained by the other fuel cell systems 100, 200, 400 and 420), such as power conditioning circuitry 35 that receives a stack voltage (called “V_{TERM}”) from the fuel cell stack 20 via a stack terminal voltage line 27. The power conditioning circuitry 35 produces a regulated AC voltage (called “V_{AC}”) in response to the V_{TERM} voltage. The V_{AC} voltage appears across output terminals 32 of the power conditioning circuitry 35 for purposes of providing power to the load 50. The power conditioning circuitry 35 may include, for example, a voltage regulator to produce a regulated voltage from the V_{TERM} voltage, and the power conditioning circuitry 35 may include an inverter to convert this regulated voltage into the V_{AC} voltage.

Among its other functions, the controller may control the general operations of the fuel cell system 10, in some embodiments of the invention. The controller 60 may monitor various system parameters and base its control of the system 10 on these monitored parameters. For example, the controller 60 may receive an indication of the stack current via communication lines 53 that extend between the power conditioning circuitry 35 and the controller 60. The controller 60 may also control the stack current using the communication lines 53. The controller 60 may, for example, monitor the cell voltages of the fuel cell stack 20 via a cell voltage monitoring circuit 40. The cell voltage monitoring circuit 40 is coupled to the fuel cell stack 20 through cell voltage monitoring lines 47; and the circuit 40 may continually scan the cell voltages of the stack 20 and provide indications of the scanned voltage to the controller 60 via a serial bus 48.

The controller 60 executes program instructions 65 that are stored in a memory 63 (of the controller 60, for example). These program instructions cause the controller 60 to perform one or more routines that are related to controlling the general monitoring and operation of the fuel cell system 10. In some embodiments of the invention, the controller 60 may include a microcontroller and/or a microprocessor to perform one or more of the techniques (techniques 150 and/or 250, as examples) that are described herein when executing the program 65. For example, the controller 60 may include a microcontroller that includes a read only memory (ROM) that serves as the memory 63 and a storage medium to store instructions for the program 65. Other types of storage mediums may be used to store instructions of the program 65. Various analog and digital external pins of the microcontroller may be used to establish communication over electrical communication lines that extend to various components of the fuel cell system 10, such as electrical communication lines 27 and 53 and the serial bus 48. Electrical interferences (not shown) may be coupled between these lines and the controller 60. In other embodiments of the invention, a memory that is fabricated on a separate die from the microcontroller may be used as the memory 63 and store instructions for the program 65. Other variations are possible.

The fuel cell systems depicted in the figures are only examples of a fuel cell system in accordance with some embodiments of the invention, as the fuel cell systems in other embodiments of the invention may include more components, less components, different components and different arrangements than that shown in the figures and described in the specification.

For example, in some embodiments of the invention, the fuel cell system may include a coolant subsystem to circulate a coolant through the fuel cell stack 20. The fuel cell system may also include water recovery devices to recover product water from the fuel cell stack 20 and return this water to the coolant subsystem. In this manner, in some embodiments of the invention, the water recovery devices may be connected in the low point of the anode circulation path and/or bleed flow path for purposes of returning water to the coolant subsystem and removing this water from the anode and/or bleed flow paths.

While the invention has been disclosed with respect to a limited number of embodiments, those skilled in the art, having the benefit of this disclosure, will appreciate numerous modifications and variations therefrom. It is intended that the appended claims cover all such modifications and variations as fall within the true spirit and scope of the invention.

1. A method usable with a fuel cell stack, comprising:
establishing a path to route an anode exhaust from the fuel cell stack back to an anode inlet port of the stack; and
diverting part of a first flow otherwise flowing through the path to produce a diverted flow; and
combining the diverted flow with a flow associated with a cathode of the stack.

2. The method of claim 1, wherein the combining comprises:
combining the diverted flow with an oxidant flow directed toward a cathode inlet port of the stack.

3. The method of claim 1, wherein the combining comprises:
combining the diverted flow with an exhaust flow from a cathode outlet port of the stack.

4. The method of claim 1, wherein a rate of the diverted flow is approximately one four hundredth that of the first flow.

5. The method of claim 1, wherein the diverting comprises:
diverting the first flow to produce the diverted flow irrespective of a power state of the fuel cell stack.

6. The method of claim 1, further comprising:
varying a rate of the first flow in response to a system performance parameter.

7. The method of claim 6, wherein the system performance parameter comprises at least one of the following:
an output power of a fuel cell system using the fuel cell stack,
an output current of a fuel cell system using the fuel cell stack,
a voltage in a system using the fuel cell stack, and
a flow rate of said flow associated with a cathode of the stack.

8. The method of claim 1, further comprising:
varying a rate of the diverted flow in response to a system performance parameter.

9. The method of claim 8, wherein the system performance parameter comprises at least one of the following:
an output power of a fuel cell system using the fuel cell stack,
an output current of a fuel cell system using the fuel cell stack,
a voltage in a system using the fuel cell stack, and
a flow rate of said flow associated with a cathode of the stack.

10. The method of claim 8, wherein the system performance parameter comprises:
a pressure differential measured between an anode exhaust port of the stack and the anode inlet port of the stack.

11. A fuel cell system comprising:
a fuel cell stack;
a circulation path to route an anode exhaust from the fuel cell stack back to an anode inlet port of the stack;
a bleed flow path to divert part of a first flow otherwise flowing through the path to produce a diverted flow; and
at least one conduit to combine the diverted flow with a flow associated with a cathode of the stack.

12. The system of claim 11, wherein said at least one conduit combines the diverted flow with an oxidant flow directed toward a cathode inlet port of the stack.

13. The system of claim 11, wherein said at least one conduit combines the diverted flow with an exhaust flow from a cathode outlet port of the stack.

14. The system of claim 11, wherein a rate of the diverted flow is approximately one four hundredth that of the first flow.

15. The system of claim 11, wherein the bleed flow path diverts the first flow to produce the diverted flow irrespective of a power state of the fuel cell stack.

16. The system of claim 11, wherein the anode circulation path comprises a blower, the system further comprising:
a controller to vary a rate of the first flow in response to a system performance parameter.

17. The system of claim 16, wherein the system performance parameter comprises at least one of the following:
an output power of a fuel cell system using the fuel cell stack,
an output current of a fuel cell system using the fuel cell stack,
a voltage in a system using the fuel cell stack, and
a flow rate of said flow associated with a cathode of the stack.

18. The system of claim 11, wherein the bleed flow path comprises a valve, the system further comprising:
a controller to vary a rate of the diverted flow in response to a system performance parameter.

19. The system of claim 18, wherein the system performance parameter comprises at least one of the following:
an output power of a fuel cell system using the fuel cell stack,
an output current of a fuel cell system using the fuel cell stack,
a voltage in a system using the fuel cell stack, and
a flow rate of said flow associated with a cathode of the stack.

20. The system of claim 18, wherein the system performance parameter comprises:
a pressure differential measured between an anode exhaust port of the stack and the anode inlet port of the stack.
